(19) United States
(12) Patent Application Publication
(10) Pub. No.: US 2014/0365445 A1
(43) Pub. Date: Dec. 11, 2014

(54) SERVER WITH FILE MANAGING FUNCTION AND FILE MANAGING METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventors: XIN LU, Shenzhen (CN); SHIH-FANG WONG, New Taipei (TW); DAN CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/101,354

(22) Filed: Dec. 10, 2013

(30) Foreign Application Priority Data
Jun. 11, 2013 (CN) 2013102310652

(51) Int. Cl. G06F 17/30

(52) U.S. Cl. CPC G06F 17/30348
USPC 707/687

(57) ABSTRACT

A server communicates with a number of terminal devices. Each terminal device stores a file having a same file name. The server generates a trace log. The trace log records modification of the file in each of the terminal devices. The server further determines whether or not one of the terminal devices opens the file, searches in the trace log according to the file name of the file to find all the modifications corresponding to the file, determines the latest modification among all the modifications in the terminal devices according to the modification time corresponding to each of the found modifications, and displays at least a part of content of the found latest modification in the terminal device which currently runs the file.

### BACKGROUND

1. Technical Field

The present disclosure relates to servers, and particularly, to a server having a file managing function and a file managing method.

2. Description of Related Art

Nowadays, users may use different types of electronic devices (e.g., laptop computers, tablet PCs) to edit a same file. For example, in office, the user uses the laptop computer to edit a file, and at home, the user uses the tablet PC to edit the file. By doing so, the user may forget which device has the latest modification version of the file, and may be confused to how to edit the file.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram showing a server connected to a number of terminal devices, in accordance with an exemplary embodiment.

FIG. 2 is a block diagram of a file managing system of the server of FIG. 1, in accordance with an exemplary embodiment.

FIGS. 3A-3B are flowcharts of a file managing method, in accordance with an exemplary embodiment.

### DETAILED DESCRIPTION

Embodiments of the present disclosure are described in detail, with reference to the accompanying drawings.

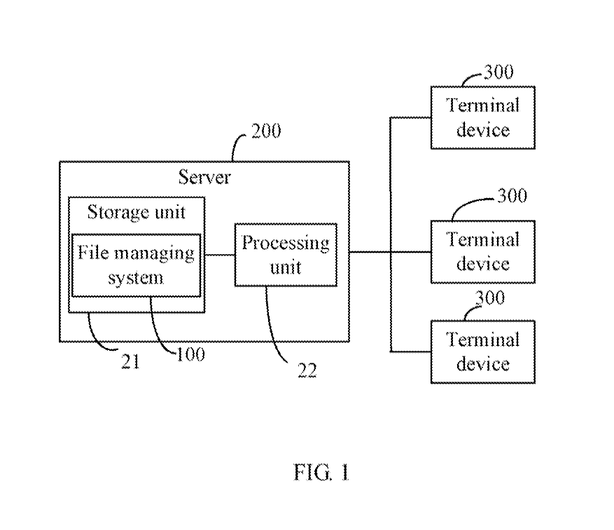

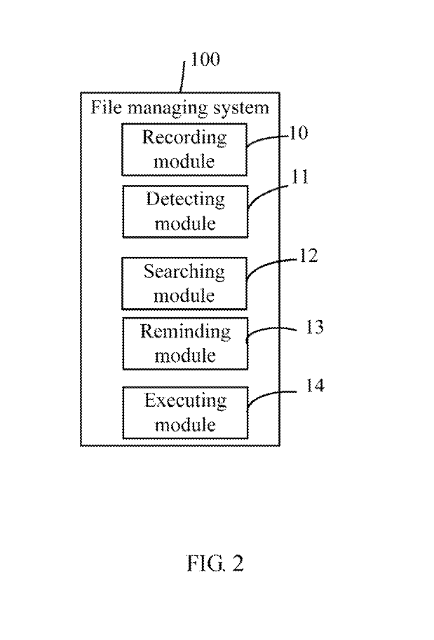

FIGS. 1-2 shows that an embodiment of a server 200 is connected to a number of terminal devices 300 and communicates with the terminal devices 300. Each terminal device 300 stores a file having a same file name. The server 200 includes a storage unit 21 and a processing unit 22. The storage unit 21 stores a number of modules of a file managing system 100. The number of modules of the file managing system 100 is executed by the processing unit 22 to perform functions of the server 200. The number of the modules of the file managing system 100 includes a recording module 10, a detecting module 11, a searching module, a reminding module 13, and an executing module 14.

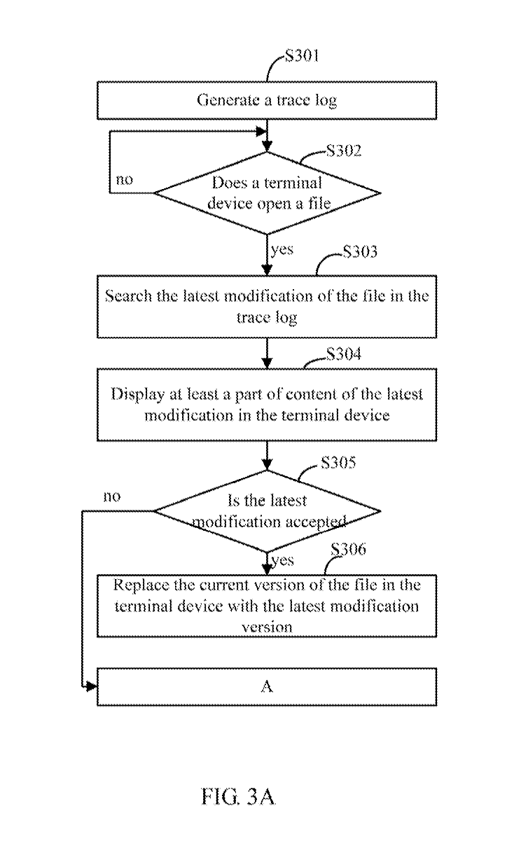

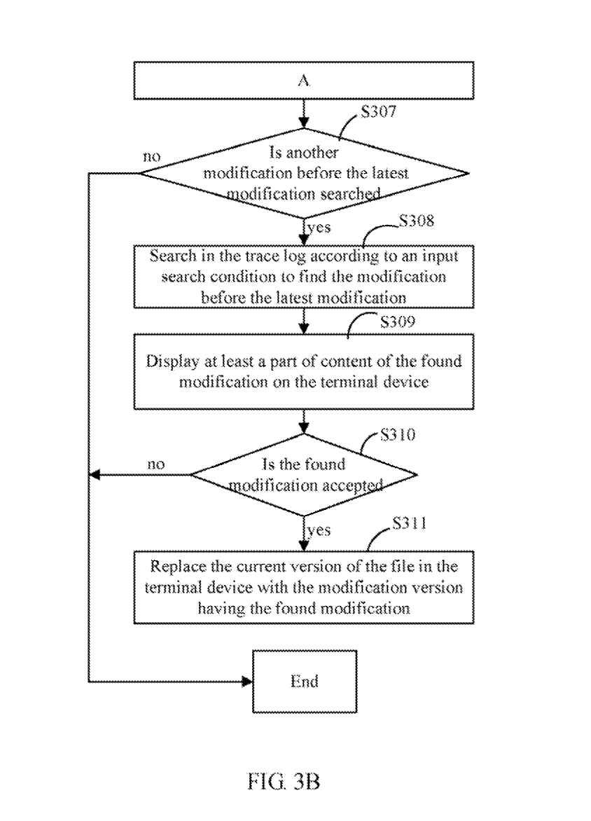

FIGS. 3A-3B are flowcharts of a file managing method, in accordance with an exemplary embodiment.

In step S301, the recording module 10 generates a trace log. The trace log records device information of each terminal device 300 and modification of the file in each terminal device 300. In this embodiment, the device information of each terminal device 300 includes an identification code (e.g., MAC address or IP address). The device information of each terminal device 300 can further include the type of each terminal device 300 (e.g., smart phone). The modification of the file includes an access path of the file in each terminal device 300, the modification time corresponding to each modification, a change of the file size (e.g., from 30 KB to 50 KB) corresponding to each modification, and a change of file content of the file corresponding to each modification (e.g., newly added content). In this embodiment, the recording module 10 records the latest modification of the file in each terminal device 300. In an alternative embodiment, the recording module 10 records each modification of the file in each terminal device 300. The device information of each terminal device 300 and the modification of the file can be transmitted to the server 200 by each terminal device 300, or obtained by the server 200 itself via monitoring each terminal device 300.

In step S302, the detecting module 11 determines whether or not one terminal device 300 opens the file. If yes, the procedure goes to step S303, otherwise, the procedure returns to step S302. The detecting module 11 determines whether or not one terminal device 300 opens the file by monitoring currently run applications of each terminal device 300 in time.

In step S303, the searching module 12 searches in the trace log according to the file name of the file to find all the modifications corresponding to the file, and determines the latest modification among all the modifications in all the terminal devices 300 according to the modification time corresponding to each modification.

In step S304, the reminding module 13 displays at least a part of content of the found latest modification in the terminal device 300 which currently runs the file. For example, the reminding module 13 displays the change of file content of the file corresponding to the found latest modification, or not only displays the change of the file content of the file corresponding to the found latest modification, but also displays the modification time corresponding to the found latest modification, and the change of file size of the file corresponding to the found latest modification. In this embodiment, the reminding module 13 further displays the device information of the terminal device 300 having the change of the file content of the found latest modification, to allow a user to know which terminal device 300 has the found latest modification.

In step S305, the executing module 14 determines whether or not the terminal device 300 which currently runs the file agrees to or refuses to accept the change of the file content of the found latest modification. If yes, the procedure goes to step S306, otherwise, the procedure goes to step S307.

In step S306, the executing module 14 obtains the latest modification version from the terminal device 300 having the change of the file content of the found latest modification according to the device information of each terminal device 300 and the access path of the file in each terminal device 300, and replaces the current version of the file in the terminal device 300 which currently runs the file with the latest modification version.

In step S307, when the terminal device 300 which currently runs the file refuses to accept the change of the file content of the found latest modification, the executing module 14 reminds the user whether to search another modification of the file before the latest modification. If yes, the procedure goes to step S308, otherwise, the procedure ends.

In step S308, the searching module 12 searches in the trace log to find the modification before the latest modification according to an input search condition. The search condition may be the identification code of one terminal device 300, or may be the modification time.

In step S309, the reminding module 13 displays at least a part of content of the found modification.

In step S310, the executing module 14 determines whether or not the terminal device 300 which currently runs the file agrees to or refuses to accept the change of the file content of the found modification. If yes, the procedure goes to step S311, otherwise, the procedure ends.

In step S311, the executing module 14 obtains the modification version from the terminal device 300 having the change of the file content of the found modification according to the device information of each terminal device 300 and the access path of the file in each terminal device 300, and replaces the current version of the file in the terminal device 300 which currently runs the file with the obtained modification version.

To clearly illustrate the present disclosure, a tablet PC, a smart phone, and a laptop computer are employed. The tablet PC, the smart phone, and the laptop computer store the file. The laptop computer has the latest modification version of the file. When the user opens the file via the tablet PC, the server 200 displays the latest modification of the file in the laptop computer on the tablet PC. Thus, the user can quickly know the latest modification of the file, and can select whether to use the latest modification version. If the user wants to know the modification of the file in the smart phone, the user can input a search condition (e.g., the MAC address of the smart phone) via the tablet PC to search the modification of the file in the smart phone.

With such configuration, when the user uses different electronic devices to edit the file, it is convenient for the user to know the latest modification of the file, and also convenient for the user to search other modification of the file before the latest modification.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A server communicating with a plurality of terminal devices, each of the plurality of the terminal devices storing a file having a same file name, the server comprising:
a storage unit storing a plurality of modules of a file managing system; and
a processing unit to execute the plurality of modules of the file managing system to perform operations of the server, the operations comprising:
generating a trace log, wherein the trace log records modification of the file in each of the plurality of terminal devices;
determining whether or not one of the plurality of terminal devices opens the file;
searching in the trace log according to the file name of the file to find all the modifications corresponding to the file, and determining the latest modification among all the modifications in the plurality of the terminal devices according to the modification time corresponding to each of the found modifications; and
displaying at least a part of content of the found latest modification in the terminal device which currently runs the file.

2. The server as described in claim 1, wherein the modification of the file in each of the plurality of terminal devices comprises an access path of the file in each of the plurality of terminal devices, the modification time corresponding to each modification, and a change of file content of the file corresponding to each modification.

3. The server as described in claim 1, wherein the trace log further records device information of each of the plurality of terminal devices, the modification of the file in each of the plurality of terminal devices comprises an access path of the file in each of the plurality of terminal devices and a change of file content of the file corresponding to each modification, the operations further comprises obtaining the latest modification version from the terminal device having the change of the file content of the found latest modification according to the device information of each of the plurality of terminal devices and the access path of the file in each of the plurality of terminal devices when the terminal device which currently runs the file agrees to accept the change of file content of the found latest modification, and replacing the current version of the terminal device which currently runs the file with the latest modification version.

4. The server as described in claim 3, wherein the operations further comprising:
reminding a user of the terminal device which currently runs the file whether to search another modification of the file before the latest modification when the terminal device which currently runs the file refuses to accept the change of the file content of the found latest modification;
searching in the trace log to find the modification before the latest modification according to an input search condition; and
displaying at least a part of content of the found modification.

5. The server as described in claim 4, wherein the operations further comprising:
obtaining the modification version from the terminal device having the change of the file content of the found modification according to the device information of each of the plurality of terminal devices and the access path of the file in each of the plurality of terminal devices when the terminal device which currently runs the file agrees to accept the change of file content of the found modification, and replacing the current version of the file in the terminal device which currently runs the file with the obtained modification version.

6. A file managing method applied in a server, the server communicating with a plurality of terminal devices, each of the plurality of the terminal devices storing a file having a same file name, the method comprising:
generating a trace log, wherein the trace log records modification of the file in each of the plurality of terminal devices;
determining whether or not one of the plurality of terminal devices opens the file;
searching in the trace log according to the file name of the file to find all the modifications corresponding to the file, and determining the latest modification among all the modifications in the plurality of the terminal devices according to the modification time corresponding to each of the found modifications; and
displaying at least a part of content of the found latest modification in the terminal device which currently runs the file.

7. The method as described in claim 6, wherein the modification of the file in each of the plurality of terminal devices comprises an access path of the file in each of the plurality of terminal devices, the modification time corresponding to each modification, and a change of file content of the file corresponding to each modification.

8. The method as described in claim 6, wherein the trace log further records device information of each of the plurality of terminal devices, the modification of the file in each of the plurality of terminal devices comprises an access path of the file in each of the plurality of terminal devices and a change of file content of the file corresponding to each modification, the method further comprises:
obtaining the latest modification version from the terminal device having the change of the file content of the found latest modification according to the device information of each of the plurality of terminal devices and the access path of the file in each of the plurality of terminal devices when the terminal device which currently runs the file agrees to accept the change of file content of the found latest modification; and
replacing the current version of the terminal device which currently runs the file with the latest modification version.

9. The method as described in claim 8, further comprising:
reminding a user of the terminal device which currently runs the file whether to search another modification of the file before the latest modification when the terminal device which currently runs the file refuses to accept the change of the file content of the found latest modification;
searching in the trace log to find the modification before the latest modification according to an input search condition; and
displaying at least a part of content of the found modification.

10. The method as described in claim 9, further comprising:
obtaining the modification version from the terminal device having the change of the file content of the found modification according to the device information of each of the plurality of terminal devices and the access path of the file in each of the plurality of terminal devices when the terminal device which currently runs the file agrees to accept the change of file content of the found modification, and replacing the current version of the file in the terminal device which currently runs the file with the obtained modification version.

11. A non-transitory storage medium storing a plurality of modules, the plurality of modules comprising instructions executable by a server to perform a file managing method, the server communicating with a plurality of terminal devices, each of the plurality of the terminal devices storing a file having a same file name, the method comprising:
generating a trace log, wherein the trace log records modification of the file in each of the plurality of terminal devices;
determining whether or not one of the plurality of terminal devices opens the file;
searching in the trace log according to the file name of the file to find all the modifications corresponding to the file, and determining the latest modification among all the modifications in the plurality of the terminal devices according to the modification time corresponding to each of the found modifications; and
displaying at least a part of content of the found latest modification in the terminal device which currently runs the file.

12. The storage medium as described in claim 11, wherein the modification of the file in each of the plurality of terminal devices comprises an access path of the file in each of the plurality of terminal devices, the modification time corresponding to each modification, and a change of file content of the file corresponding to each modification.

13. The storage medium as described in claim 11, wherein the trace log further records device information of each of the plurality of terminal devices, the modification of the file in each of the plurality of terminal devices comprises an access path of the file in each of the plurality of terminal devices and a change of file content of the file corresponding to each modification, the method further comprises:
obtaining the latest modification version from the terminal device having the change of the file content of the found latest modification according to the device information of each of the plurality of terminal devices and the access path of the file in each of the plurality of terminal devices when the terminal device which currently runs the file agrees to accept the change of file content of the found latest modification; and
replacing the current version of the terminal device which currently runs the file with the latest modification version.

14. The storage medium as described in claim 13, wherein the method further comprising:
reminding a user of the terminal device which currently runs the file whether to search another modification of the file before the latest modification when the terminal device which currently runs the file refuses to accept the change of the file content of the found latest modification;
searching in the trace log to find the modification before the latest modification according to an input search condition; and
displaying at least a part of content of the found modification.

15. The storage medium as described in claim 14, wherein the method further comprising:
obtaining the modification version from the terminal device having the change of the file content of the found modification according to the device information of each of the plurality of terminal devices and the access path of the file in each of the plurality of terminal devices when the terminal device which currently runs the file agrees to accept the change of file content of the found modification, and replacing the current version of the file in the terminal device which currently runs the file with the obtained modification version.
